(19) United States
(12) Patent Application Publication
(10) Pub. No.: US 2025/0114865 A1
(43) Pub. Date: Apr. 10, 2025

(54) METHOD AND DEVICE FOR CHANGING PROCESSING PARAMETER VALUES DURING A BEAM PROCESSING METHOD

(71) Applicant: TRUMPF Werkzeugmaschinen SE + Co. KG, Ditzingen (DE)

(72) Inventors: Tobias Kaiser, Rutesheim (DE); Martin Petera, Stuttgart (DE); Christoph Kraus, Renningen (DE)

(21) Appl. No.: 18/985,126

(22) Filed: Dec. 18, 2024

Related U.S. Application Data
(63) Continuation of application No. PCT/EP2023/066501, filed on Jun. 19, 2023.

(30) Foreign Application Priority Data
Jun. 23, 2022 (DE) 10 2022 115 672.9

(51) Int. Cl. B23K 26/08; B23K 26/38

(52) U.S. Cl. CPC B23K 26/0876; B23K 26/38

(57) ABSTRACT

A method for changing processing parameter values while a beam processing method is carried out includes changing an advancement speed of the beam processing method relative to a predefined advancement speed, and changing a value of a second processing parameter of the beam processing method relative to a predefined value for the second processing parameter according to a change in the advancement speed.

### CROSS REFERENCE TO RELATED APPLICATIONS

This application is a continuation of International Application No. PCT/EP2023/066501 (WO 2023/247460 A1), filed on Jun. 19, 2023, and claims benefit to German Patent Application No. DE 10 2022 115 672.9, filed on Jun. 23, 2022. The aforementioned applications are hereby incorporated by reference herein.

### FIELD

Embodiments of the present invention relate to the field of beam processing methods, in particular laser processing methods. In particular, embodiments of the invention relate to a method and a device for changing processing parameter values compared to predefined values during a beam processing method.

### BACKGROUND

In relation to beam processing methods, it is known to adjust other processing parameters accordingly when the processing speed, i.e. the advancement speed of the processing beam relative to the workpiece surface to be processed, is changed. When laser cutting metal workpieces, for example, it is a common measure to reduce the advancement speed of the cutting beam when cutting corners or tight radii in order to achieve good cutting quality in these contour regions. When the advancement speed is reduced, other cutting parameters usually also have to be adjusted in order to achieve an optimal cutting result. These other cutting parameters include laser power, cutting gas pressure, focal position, distance of the cutting head to the workpiece and others. Such parameter changes during the processing of a workpiece are usually pre-programmable and can be selected according to the contour to be processed, so a processing machine that carries out the processing method adjusts the parameter values independently.

DE10040920A1, for example, discloses a method for process control of a laser processing process in which a travel speed of the laser processing head is set manually or automatically and the laser power is adjusted when the travel speed changes according to a predefined dependency on the travel speed.

Beam processing systems also offer the possibility of manually controlling the advancement speed during the processing process, for example by means of a so-called potentiometer. By manually intervening in the ongoing process, operating personnel can manually reduce the advancement speed relative to the predefined advancement speed in order to gain a better overview and time to think in the event of dangers being discovered at short notice. Even when introducing new processing processes in which the optimum processing speed has not yet been determined, the personnel can approach the optimum advancement speed by making manual changes.

If the advancement speed is changed manually during the processing method, other processing parameters are generally not adjusted. In this way, the operating personnel can, for example, specifically generate an excess of power in the processing method by reducing the advancement speed and thus increase process reliability during laser cutting. However, as the laser power increases, the problem arises that if the excess of power is too much, the workpiece support region and other machine components can be damaged or even destroyed. There is therefore a need for a solution for advancement regulation—in particular manual advancement regulation—in which machine components, in particular the workpiece holder or workpiece support, are not endangered even at high rated outputs of the beam processing machine (for example, in the case of a laser cutting machine from 10 kW laser power).

### SUMMARY

Embodiments of the present invention provide a method for changing processing parameter values while a beam processing method is carried out. The method includes changing an advancement speed of the beam processing method relative to a predefined advancement speed, and changing a value of a second processing parameter of the beam processing method relative to a predefined value for the second processing parameter according to a change in the advancement speed.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a laser cutting machine for laser beam cutting in a schematic, perspective view, according to some embodiments;

FIG. 2 shows an operating panel for inputting control and/or regulating commands to a laser cutting machine according to FIG. 1, according to some embodiments; and

FIG. 3 and FIG. 4 each show a diagram illustrating the dependence of a laser power change on a change in the advancement speed according to some embodiments.

### DETAILED DESCRIPTION

Embodiments of the invention provide a method for changing processing parameter values while a beam processing method is being carried out. In other words, for the beam processing method, values for processing parameters are already predefined (e.g. pre-programmed) with which the method is carried out and which can also be changed in addition to pre-programmed changes.

The method comprises, in a first step, changing an advancement speed of the beam processing method relative to a predefined advancement speed. The advancement speed is the speed at which the processing beam of the beam processing method is moved relative to a workpiece surface to be processed. The advancement speed can preferably be changed manually. This can be done, for example, using a potentiometer. The predefined advancement speed is understood to mean in particular an advancement speed pre-programmed for the beam processing method. The predefined advancement speed does not have to be a constant advancement speed. For example, the predefined advancement speed along a contour of a workpiece to be processed can be pre-programmed with different values. For example, the advancement speed predefined for a processing process can be predefined to be higher along a straight contour section than along a curved or corner region of the contour to be processed. The change in the advancement speed according to embodiments of the invention refers to the advancement speed values predefined for the processing process, regardless of whether these already differ from one another.

In a second step, the method comprises changing the value of a second processing parameter of the beam processing method relative to a value predefined for the second processing parameter and according to the change in the advancement speed according to the first step. In the context of this disclosure, the advancement speed can also be understood as the first processing parameter.

With regard to the second processing parameter, it is also understood that the predefined processing parameter values refer to the values pre-programmed for the current beam processing method. A change in the second processing parameter value according to embodiments of the invention therefore only occurs when the values of the second parameter are changed relative to the parameter values pre-programmed for the current processing method.

According to embodiments of the present invention, the second processing parameter is automatically adjusted in the event of a, preferably manual, change in the advancement speed and according to a predefinable dependency on the advancement speed. In this way, the process can be better controlled, especially when there are large changes in the advancement speed.

According to one variant, the values of other processing parameters (third, fourth, fifth processing parameters, etc.) predefined or preset for the beam processing method can also be changed automatically, analogous to the change in the second processing parameter value, according to the change in advancement speed.

The beam processing method may preferably be a laser processing method, in particular a laser cutting method. In principle, however, embodiments of the invention can also be applied to other beam processing methods, such as electron beam processing, other thermal separation or joining processes, water jet cutting, and other related methods.

When applying embodiments of the invention in a laser processing method, the second processing parameter may preferably be a laser power. However, the second processing parameter can also be, for example, the focal position of the processing laser beam, the distance between a processing head and the workpiece surface, or the pressure of a process gas used for the laser processing method.

When the advancement speed is reduced, the laser power can preferably be reduced according to embodiments of the present invention. According to the prior art, if the advancement speed is reduced compared to predefined values, there is a risk of an excess of power, which can damage or destroy machine components. For example, during laser beam cutting of a plate-like metallic workpiece, the distance energy of the processing beam that impinges on the workpiece support (in particular a metal grating) through the generated cutting gap can be so high that the workpiece support is deformed or melts. By automatically reducing the laser power in the event of a manual reduction in the advancement speed, an uncontrolled excess of power and subsequent damage to machine components can be prevented.

According to a preferred variant, when the advancement speed is reduced by up to 30% relative to the predefined advancement speed, the laser power can be reduced to a lesser extent than the advancement speed or not at all. For example, the laser power cannot be reduced by a manual reduction in the advancement speed relative to the pre-programmed advancement speed, preferably by up to at least 10%, e.g. by about 20%. In this way, a controlled excess of power can be generated, which can increase process reliability in the relevant processing section. If the advancement speed is further reduced, the laser power can also be reduced, preferably to the same degree as the advancement speed. In this way, the excess of power generated at the beginning of the feed deceleration can be maintained in a controlled manner during the further reduction in the advancement speed.

There can preferably be a linear relationship between the change in advancement speed according to embodiments of the invention and the change in laser power.

According to a further variant, a minimum value or minimal value can be predefined for the laser power, the laser power being kept at the minimum value upon reaching the minimum value when the advancement speed is further reduced. The minimum value for the laser power can be selected such that, regardless of the advancement speed, damage to machine components can be at least largely precluded. If the processing beam comes to a complete standstill, i.e. if the advancement speed is reduced to zero, the laser power can also be reduced, in particular rapidly, to zero.

The laser power of a laser processing method in which a method according to embodiments of the invention is carried out can preferably be at least 10 kW. This means that the value of the laser power predefined for the laser processing method can be at least 10 kW, at least in some sections. At lower laser powers, damage to machine components is generally less critical. In this respect, the positive effects of the embodiments of the present invention are evident in the specified range of laser power from 10 kW.

Embodiments of the invention further provide a laser cutting method for cutting a plate-like or tubular workpiece, the method being implemented according to at least one of the variants described above. The laser cutting method comprises, in a first step, providing a plate-like or tubular workpiece. The workpiece may, for example, consist of a metallic material, in particular of mild steel, and/or, for example, have a thickness of at least 2 mm, preferably of at least 10 mm.

In a second step, the laser cutting method comprises cutting the workpiece using a predefined advancement speed and a predefined laser power. As stated above, the predefined laser power can be at least 10 kW. The predefined advancement speed of the cutting beam can vary over the contour course according to the contour to be cut.

In a third step, the laser cutting method comprises manually changing, in particular reducing, the advancement speed compared to the predefined advancement speed; and, in a fourth step, automatically changing the laser power relative to the predefined laser power and according to the change in the advancement speed.

Further advantageous variants of the laser cutting method arise in connection with the features of the method described above for changing processing parameter values, here cutting parameter values. In particular, the laser power can only be reduced if the advancement speed is reduced by at least 10%, e.g. 20%, relative to the predefined advancement speed. Alternatively or additionally, the laser power can only be reduced to a predefined lower limit at which critical damage to machine components is very unlikely or can even be excluded, regardless of the advancement speed of the cutting beam.

Embodiments of the invention also provide a beam processing system. The beam processing system may be, in particular, a laser cutting system. The beam processing system comprises a beam processing machine, in particular a laser cutting machine, which is designed for processing plate-like or tubular, in particular metallic, workpieces. Furthermore, the beam processing system comprises a control device which is designed to control the beam processing machine for carrying out a beam processing method, in particular a laser cutting method, with predefinable processing parameters; as well as a controller for manually changing the advancement speed relative to a predefined advancement speed during the execution of the beam processing method. The control device is designed to change the value of a second processing parameter, in particular the value of a laser power, relative to a predefined value for this processing parameter and according to the manual change in the advancement speed.

The control device may comprise an operating panel for inputting commands to the beam processing machine, with the controller being arranged on the operating panel. By means of the controller, which can preferably be designed as a control knob, the advancement speed can be changed manually during the automated, in particular pre-programmed, processing method. The controller can preferably be a potentiometer. The controller can also be implemented, for example, as a touch function in a touch display of the operating panel.

Embodiments of the invention further provide a computer program product which contains computer-readable information for carrying out a method according to one of the variants described above.

Preferably, the computer program product, which may comprise a computer program with a program code, can be read by the control device of a beam processing system as described above.

### EXEMPLARY EMBODIMENTS

Exemplary embodiments are described in more detail in conjunction with the drawings.

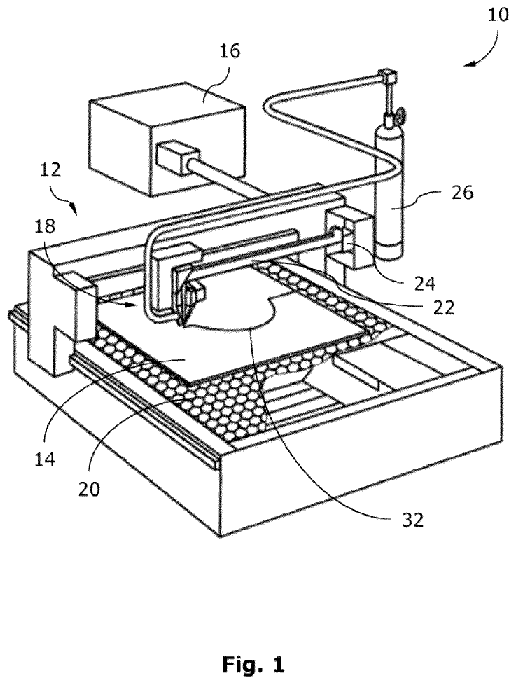

FIG. 1 shows a laser cutting system 10 with a laser cutting machine 12 and a metallic workpiece 14 arranged on the laser cutting machine 12 for laser beam cutting. The laser cutting machine 12 preferably has a CO2 laser, a solid-state laser or a diode laser as laser beam source 16, a movable cutting head 18 and a workpiece support 20, on which the metallic workpiece 14 is arranged. The laser beam 22, which is guided from the laser beam source 16 to the cutting head 18 by means of a fiber optic cable (not shown) or bending mirrors 24, is generated in the laser beam source 16. The laser beam 22 is directed at the metallic workpiece 14 by means of a focusing optical unit arranged in the cutting head 18. The laser cutting machine 12 is also supplied with cutting gas 26—for example with oxygen and/or nitrogen. The cutting gas 26 is supplied to the cutting head 18—preferably in a pressure-controlled manner—from which it exits together with the laser beam 22. The laser cutting machine 12 further comprises a control device which is programmed to move the cutting head 18 according to a cutting contour 32 relative to the metallic workpiece 14. The control device comprises an operating panel (not shown in FIG. 1) on which control commands for the laser cutting machine 12 can be input by operating personnel of the laser cutting system 10.

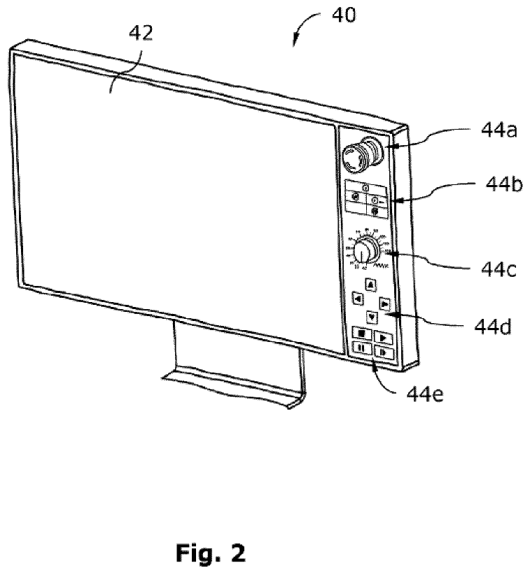

FIG. 2 shows an operating panel 40 for a beam processing system according to embodiments of the invention—in particular a laser cutting system 10 according to FIG. 1. In particular, the operating panel 40 can be part of a control device of a laser cutting system or another beam processing system. The operating panel 40 comprises a screen 42 for displaying functions and information for operating the beam processing system. Furthermore, the operating panel comprises control and/or regulating elements 44a-e, with the aid of which, for example, the functions displayed on the screen 42 for setting and/or controlling processing processes that can be carried out by means of the beam processing system can be controlled. The screen 42 or the display 42 can also include a touch function, which supplements or replaces the control and/or regulating elements 44a-e shown. For example, a cutting process for cutting the contour 32 can be set by means of the operating panel 40 on a laser cutting system 10 according to FIG. 1. To carry out the cutting process, cutting parameters are predefined—e.g. according to the material of the workpiece 14, the workpiece thickness and/or the cutting contour. The cutting parameters can be based on a technology table that is stored in the control device of the laser cutting system 10. Among other things, an advancement speed at which the workpiece 14 is cut is predefined. The predefined advancement speed can be changed, in particular reduced, during the cutting process by means of a control knob 44c of the control and/or regulating elements 44a-e. According to embodiments of the invention, the laser power is also adjusted according to the manual change in the advancement speed in order to prevent a critical excess of power in the cutting process and to protect the machine components from damage.

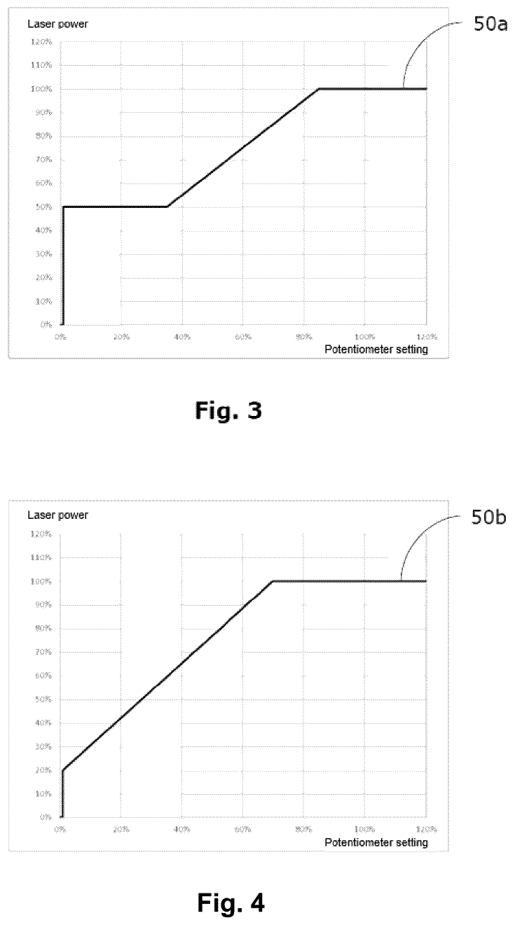

Examples of dependencies of the laser power on the advancement speed in the case of manual (re)adjustment of the advancement speed are shown in FIGS. 3 and 4. The horizontal axis of the diagrams indicates percentage values for the advancement speed (“potentiometer position” or position of the control knob 44c on the operating panel 40) during a laser cutting process, with the value “100%” corresponding to the advancement speed predefined for the process in question and at the position of the cutting contour. The laser power is indicated on the vertical axis—also as a percentage of the laser power predefined for the current process. According to curve 50a in FIG. 3, the laser power is initially maintained when the advancement speed is reduced by up to about 15%. If the advancement speed is further reduced, the laser power is also reduced—here linearly with respect to the advancement speed. If the laser power reaches a minimum value or minimum value of 50% of the predefined laser power, it will not be reduced any further even if the advancement speed is further reduced. The minimum value can be predefined variably depending on the requirements of the cutting process. Only when the cutting beam is completely stopped or immediately before stopping, i.e. when the advancement speed is reduced to 0%, is the laser switched off and the laser power reduced to 0%. By delaying the reduction of the laser power when manually reducing the advancement speed, an excess of power can be generated in the cutting process and thus, if necessary, the process reliability can be specifically increased. Setting a minimum value for the laser power can also help ensure process reliability. Preferably, the minimum value for the laser power can be selected such that damage to machine components—in particular damage to a workpiece support 20 (see FIG. 1)—can be at least largely precluded.

FIG. 4 shows another example of a conditional change in laser power during manual readjustment of the advancement speed in a laser cutting process. As shown in FIG. 4, the laser power is only reduced when the advancement speed is reduced by more than 30%. A minimum value for the laser power is set at 20% as shown in FIG. 4. There is only a drop below this value if the advancement speed is completely reduced to 0% or shortly before, namely also by reducing the laser power to 0%.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for changing processing parameter values while a beam processing method is carried out, the method comprising:
changing an advancement speed of the beam processing method relative to a predefined advancement speed; and
changing a value of a second processing parameter of the beam processing method relative to a predefined value for the second processing parameter according to a change in the advancement speed.

2. The method according to claim 1, wherein the beam processing method is a laser processing method.

3. The method according to claim 2, wherein the second processing parameter is a laser power.

4. The method according to claim 3, wherein the laser power is reduced when the advancement speed is reduced.

5. The method according to claim 3, wherein, when the advancement speed is reduced by up to 30% relative to the predefined advancement speed, the laser power is not reduced or is reduced to a lesser extent than the change in the advancement speed.

6. The method according to claim 3, wherein a linear relationship exists between the change in the advancement speed and a change in the laser power.

7. The method according to claim 3, wherein a minimum value is predefined for the laser power, and wherein the laser power is kept at the minimum value upon reaching the minimum value when the advancement speed is further reduced.

8. A method according to claim 3, wherein the laser power is at least 10 kW.

9. A laser cutting method for cutting a plate-like or tubular workpiece, the laser cutting method comprising:
providing a plate-like or tubular workpiece;
cutting the workpiece using a predefined advancement speed and a predefined laser power;
manually changing the advancement speed relative to the predefined advancement speed; and
automatically changing the laser power relative to the predefined laser power according to a change in the advancement speed.

10. A beam processing system comprising:
a beam processing machine configured for processing plate-like and/or tubular workpieces;
a control device configured to control the beam processing machine for carrying out a beam processing method with predefinable processing parameters; and
a controller for manually changing an advancement speed relative to a predefined advancement speed during execution of the beam processing method;
wherein the control device is configured to change a value of a second processing parameter relative to a predefined value according to a change in the advancement speed.

11. The beam processing system according to claim 10,
wherein the control device comprises an operating panel for inputting commands to the beam processing machine; and
wherein the controller is arranged on the operating panel.

12. A non-transitory computer-readable medium having program steps stored thereon, the program steps, when executed by a computer processor, causing performance of a method according to claim 1.
